(19) United States
(12) Patent Application Publication
(10) Pub. No.: US 2024/0189939 A1
(43) Pub. Date: Jun. 13, 2024

(54) BATTERY ENCLOSURE WITH REMOVABLE COVER SECTIONS

(71) Applicant: Ford Global Technologies, LLC, Dearborn, MI (US)

(72) Inventors: Stuart C. Salter, White Lake, MI (US); Renata Michaela Arsenault, Plymouth, MI (US); Kent Snyder, Dearborn, MI (US); Brian Joseph Robert, Saint Clair Shores, MI (US); Ann O'Neill, Dearborn, MI (US); David Brian Glickman, Southfield, MI (US)

(73) Assignee: Ford Global Technologies, LLC, Dearborn, MI (US)

(21) Appl. No.: 18/077,705

(22) Filed: Dec. 8, 2022

(51) Int. Cl. B23K 26/03; B23K 26/38; B26D 1/06; B26D 1/12; B26D 5/00; B26F 3/00; G01B 21/20; H01M 50/271

(52) U.S. Cl. CPC B23K 26/032; B23K 26/38; B26D 1/06; B26D 1/12; B26D 5/007; B26F 3/004; G01B 21/20; H01M 50/271; H01M 2220/20

(57) ABSTRACT

A system for recycling a component of a battery assembly includes a removal tool and a cover of the battery assembly. The cover includes a component removal zone configured to be removable from the cover by the removal tool to expose the component and a locator identifying the component removal zone for removal by the removal tool.

### FIELD

The present disclosure relates to recyclable vehicle batteries, particularly battery enclosures with removable covers.

### BACKGROUND

The statements in this section merely provide background information related to the present disclosure and may not constitute prior art.

The desire to reduce automotive fuel consumption and emissions has been well documented. Thus, electric vehicles have been developed to significantly reduce reliance on internal combustion engines. In general, electric vehicles differ from conventional motor vehicles because they are driven by one or more rechargeable battery packs disposed within a battery housing and having lithium-ion batteries cell assemblies such as modules or arrays, for example, or any other suitable electrical power storage units. The battery pack typically powers one or more motors to drive a set of wheels.

Battery assemblies for electric vehicles may use replaceable and recyclable components. For example, a battery cell array can be routinely replaced during the lifetime of the electric vehicle. The battery cell array can then be recycled to use in new vehicle batteries. Conventional battery assemblies seal the battery cell array within an enclosure. It can be difficult to efficiently remove these components for recycling or service.

The present disclosure addresses these and other challenges related to vehicle batteries.

### SUMMARY

This section provides a general summary of the disclosure and is not a comprehensive disclosure of its full scope or all of its features.

In one form, a method for removing a component from a battery assembly includes detecting, via a sensor, data identifying a locator on a cover of the battery assembly, the locator indicating a removal zone of the cover, adjusting, via a controller, a path of a removal tool based on the data identifying the locator, actuating the removal tool along the adjusted path to separate the removal zone from a remainder of the cover, and removing the component covered by the removal zone of the cover.

In variations of the method, which may be implemented individually or in combination: the locator includes a pattern printed onto the cover, and the method further includes actuating the removal tool along the pattern to remove the removal zone from the remainder of the cover; the locator includes an identifying mark corresponding to a virtual model of the cover, the virtual model indicating the cover and the removable zone of the cover, and the method further includes adjusting the path of the removal tool based on the virtual model; the locator includes a protrusion indicating a three-dimensional position on the cover, and the method further includes adjusting three-dimensional coordinates of the path of the removal tool based on the three-dimensional position of the protrusion; the locator includes a tab and a perforated outline of the removal zone, and the method further includes attaching the removal tool to the tab, pulling the tab away from the cover, and separating perforations of the perforated outline to separate the removal zone from the remainder of the cover; the sensor is configured to collect three-dimensional coordinate data of the cover; the sensor is one of a lidar, a sonar, an ultrasonic sensor, an x-ray sensor, an infrared imaging sensor, a neutron imaging sensor, and a vision system; the component is one of a cell array, a control module, and an electronic connection.

In another form, a battery assembly includes a housing including a base and a cover, the base and the cover defining an interior cavity of the housing and a battery component disposed within the cavity of the housing. The cover includes a component removal zone configured to be removed from a remainder of the cover and arranged to cover the battery component, and a locator identifying the component removal zone for removal.

In variations of the battery assembly, which may be implemented individually or in combination: the locator includes a pattern delimiting the component removal zone from the remainder of the cover; the locator includes an identifying mark corresponding to a virtual model of the cover, the virtual model indicating the component removal zone of the cover; the locator includes a protrusion indicating a three-dimensional position on the cover; the locator includes a tab and a perforated or thinned outline of the component removal zone.

In another form, a system for accessing a component of a battery assembly behind a cover of the battery assembly includes a removal tool configured to separate a component removal zone of the cover from a remainder of the cover, a sensor configured to detect a locator on the cover of the battery assembly, and a controller configured to receive data from the sensor and identify a location of the component removal zone based on the received data. The controller is configured to operate the removal along a removal path to separate the component removal zone from the remainder of the cover.

In variations of the system, which may be implemented individually or in combination: the removal path includes a plurality of three-dimensional coordinates to remove the component removal zone; the controller is programmed to, upon identifying three-dimensional coordinates of the locator, to determine a coordinate transformation between the three-dimensional coordinates of the locator and a default three-dimensional coordinate system of the removal tool; the controller is programmed to transform coordinates of a predetermined path into coordinates of an adjusted removal path based on the coordinate transformation; the sensor is configured to collect three-dimensional coordinate data of the cover; the sensor is one of a lidar, a sonar, an ultrasonic sensor, an x-ray sensor, an infrared imaging sensor, a neutron imaging sensor, and a vision system; the removal tool includes one of a laser cutter, a water jet cutter, an oscillating blade, and a rotatable blade.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic bottom view of a vehicle including a battery assembly according to the present disclosure;

FIG. 2 is a schematic perspective view of a printed pattern applied to a battery assembly according to the present disclosure;

FIG. 3 is a schematic view of a virtual model of a battery assembly according to the present disclosure;

FIG. 4 is a schematic perspective view of a plurality of locators installed on a battery assembly according to the present disclosure;

FIG. 5 is a view of tabs installed on a battery assembly according to the present disclosure;

FIG. 6 is a schematic perspective view of a portion of a cover of a battery assembly according to the present disclosure; and

FIG. 7 is a cross-sectional view of a border of a component removal zone according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

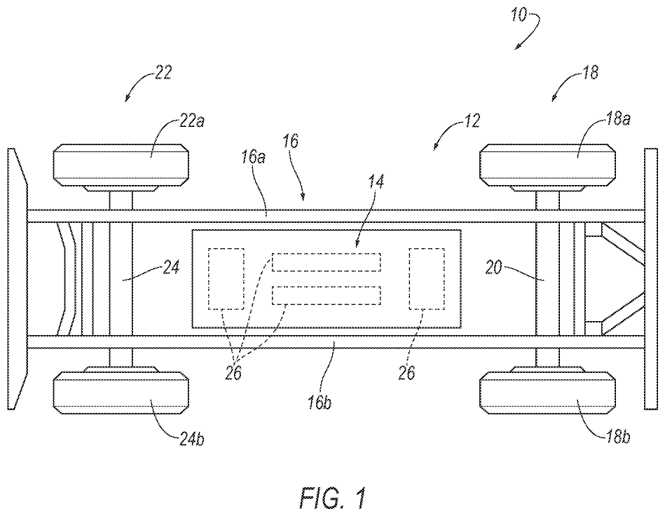

With reference to FIG. 1, a vehicle 10 such as an electric vehicle is provided. In the example provided, the electric vehicle is a battery electric vehicle (BEV). In other examples, the electric vehicle may be a hybrid electric vehicle (HEV), a plug-in electric vehicle (PHEV), or a fuel cell vehicle, among others. The vehicle 10 includes a vehicle frame 12 and a battery assembly 14. The vehicle frame 12 is the main supporting structure of the vehicle 10, to which various components are attached either directly or indirectly. The vehicle frame 12 includes opposed longitudinal rails 16a, 16b of a set of rails 16. The rails 16a, 16b are spaced apart from each other and may establish a length of the vehicle frame 12.

The battery assembly 14 powers a rear motor (not shown) to drive rear wheels 18a, 18b of a set of rear wheels 18 via a rear axle 20. Additionally or alternatively, the battery assembly 14 powers a front motor (not shown) to drive front wheels 22a, 22b of a set of front wheels 22 via a front axle 24. The battery assembly 14 includes one or more components 26, such as one or more cell arrays, a control module, and an electronic connection for example. Each cell array includes a plurality of battery cells that provide and store electricity, and the electronic connection provides electricity from the cell array to one or more other vehicle components, such as the front and rear motors for example. The control module receives instructions from a central vehicle computer (not shown) and instructs or otherwise controls the cell array to provide power to the electronic connection. The components 26 are removable from the battery assembly 14 for recycling or repair, and new or refurbished components 26 can be placed back in the battery assembly 14 to replace the removed components 26.

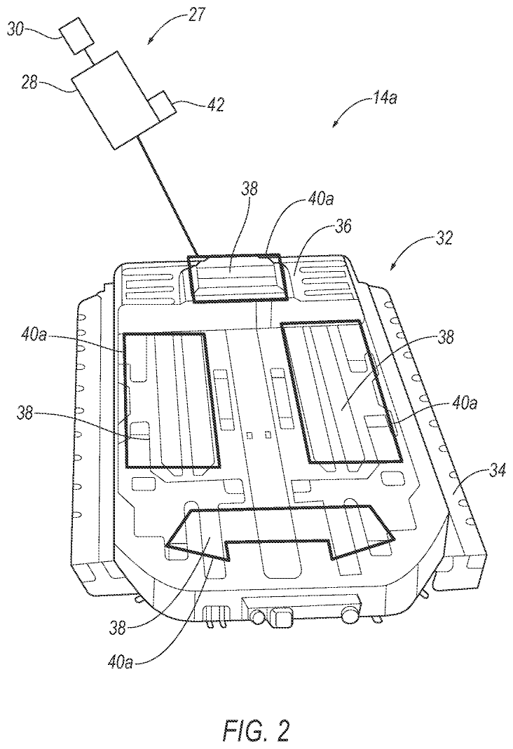

With reference to FIGS. 2-5, battery assemblies 14a, 14b, 14c, 14d of different forms according to the present disclosure are illustrated. The battery assemblies 14a, 14b, 14c, 14d can be used as the battery assembly 14 (FIG. 1). The features of the battery assemblies 14a, 14b, 14c, and 14d may be individually used or used together in any combination. The battery assembly 14a, 14b, 14c, 14d includes a housing 32 that houses the one or more of the components 26 (FIG. 1) described above. The housing 32 includes a base 34 and cover 36, the base 34 and the cover 36 defining an interior cavity of the housing 32 that houses the one or more components 26 (FIG. 1).

The cover 36 includes one or more component removal zones 38 that cover the one or more components 26 disposed in the interior cavity. In other words, these removal zones 38 do not encompass the entire cover 36. Instead, the removal zones 38 overlap specifically with the removable or serviceable components 26 but not necessarily with other areas of the housing 32 where other, non-removable or non-serviceable components (not shown) may reside.

The cover 36 can include at least one locating feature, referred to herein as a locator 40a, 40b, 40c, 40d (collectively or generally, “locator(s) 40”) that assist in identifying or locating the component removal zones 38. The locators 40 described herein may be defined by topology of the cover 36 or may include additional components to assist in identifying or locating the component removal zones 38.

Referring to FIGS. 2-5, a system 27 for removing the removal zones 38 from the cover 36 is also shown. The system 27 includes a removal tool 28, a controller 30, and at least one sensor 42. The controller 30 is in communication with and configured to operate or otherwise control the removal tool 28 and the sensor 42. In a non-limiting example, the sensor 42 can be any suitable type of sensor, such as a lidar, a sonar, an ultrasonic sensor, an x-ray sensor, an infrared imaging sensor, a neutron imaging sensor, or a vision system (e.g., a camera), that collects data, e.g., positional data, about the cover 36. While the sensor 42 is illustrated as being attached to the removal tool 28, the sensor 42 may be separate therefrom.

The system 27 is configured to remove the component removal zones 38 from the cover 36. The system 27 identifies the component removal zones 38 based on data about the locator(s) 40 detected by the sensor 42. In the non-limiting form of FIGS. 2-5, the removal tool 28 is one of a laser cutter, a water jet cutter, a rotatable blade, an oscillating cutting tool, and a hook, though other configurations can be used, such as a flame cutter, a plasma cutter, an electrical discharge machining device, a computer numerical control device, a pyrotechnic separator, and combinations thereof. In one form, the removal tool 28 is movable relative to the battery assembly 14a, 14b, 14c, 14d, by a mechanism (not shown), such as a movable jig, a robotic arm, or a robotic gantry for example, based on a predetermined cutting program to remove the component removal zones 38 from the cover 36.

In the case of the removal tool 28 is configured to physically contact the cover 36 (e.g., a rotatable blade, an oscillating cutting tool), the cutting program can be a removal path is a set of three-dimensional coordinates along which the removal tool 28 moves to separate the component removal zones 38 from the rest of the cover 36.

In the case where the removal tool 28 acts on the cover 36 remotely (e.g., a laser cutter, a water jet cutter), the cutting program may be a set of three-dimensional coordinates (i.e., a removal path) along which the removal tool 28 directs the laser or water jet to separate the removal zones 38 from the rest of the cover 36. In one such form of this configuration, the cutting program moves the removal tool 28 along a three-dimensional path to direct the laser or water jet to separate the component removal zones 38 from the rest of the cover 36. In an alternative form of this configuration, the cutting program may move the removal tool 28 along a two-dimensional path while controlling intensity values (e.g., power level or focus distance configured to cut through only the thickness of the cover 36 but not through other components behind the cover 36). In another alternative form of this configuration, the removal tool 28 may remain in a fixed XYZ coordinate location while the cutting program pivots the removal tool 28 (or at least the laser beam or water jet coming therefrom) to direct the laser or water jet while controlling the intensity values accordingly to separate the component removal zones 38 from the rest of the cover 36.

The controller 30 adjusts the cutting program based on data collected by the sensor 42, such as data identifying the locator 40, described in further detail below for each form of the locator 40.

The system 27 may optionally include a relocation device (not specifically shown) that removes or assists in relocating the removal zone 38 from the rest of the cover 36 after the removal zone 38 is severed from the rest of the cover 36. In some non-limiting examples, such a relocation device may include a gripper, a hook, a magnet (electromagnet or permanent magnet), a mechanical clamp, a vacuum or suction clamp. Such a relocation device may be coupled to the removal tool 28 for movement therewith or may be separate from the removal tool 28 for movement independent of the removal tool 28. In some non-limiting examples, such a relocation device may be mounted on a robotic arm, a gantry, a cable, a movable robot, a hand-held tool, a conveyor, or other suitable device.

With reference to FIG. 2, the locator 40a shown is a visible pattern 40a disposed on the cover 36. The pattern 40a delimits the component removal zones 38 from the rest of the cover 36. In other words, each component removal zone 38 has its own pattern 40a that visibly defines the bounds of that component removal zone 38 on the cover 36. The controller 30 determines the removal path based on the pattern and controls the removal tool 28 to cut the cover 36 at locations identified by the pattern 40a. That is, the sensor 42 can collect image data of the cover 36 and transmit the data to the controller 30, which identifies the visible pattern 40a with an image processing technique and determines the removal path as the three-dimensional coordinates of the identified visible pattern 40a. In one form, the controller 30 actuates a laser or a water jet of the removal tool 28 along the visible pattern 40a to separate the component removal zones 38 from the cover 36. The visible pattern 40a is applied to the cover 36 by one or more of printing, marking, or etching. As used herein “visible” refers to the pattern being visible by the sensor 42 and may or may not be visible to an unaided human eye. For example, the pattern may optionally be in an ultraviolet ink.

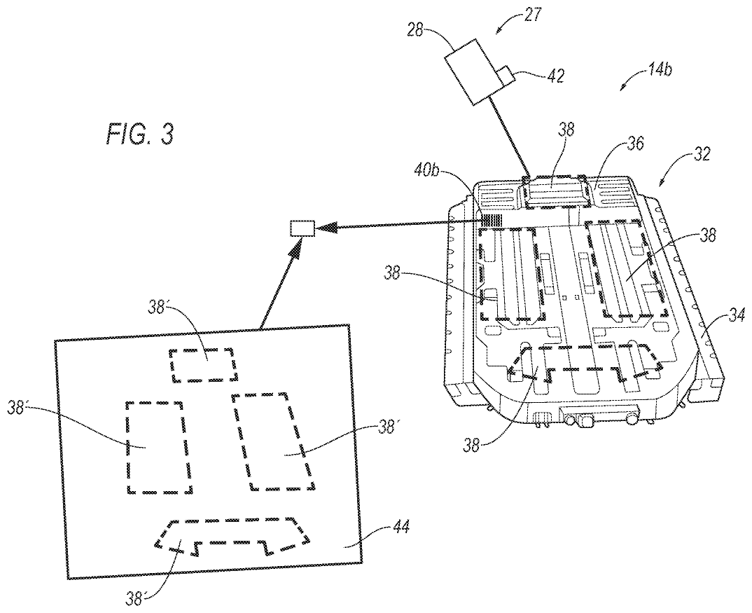

Referring now to the battery assembly 14b of FIG. 3, the locator 40b shown is an identifying mark 40b corresponding to a virtual model 44 of the cover 36. In this context, a “virtual model” is a computer-generated image, model, or map of the cover 36 stored in a memory of the controller 30 and indicates the removal path for the component removal zones 38 on the cover 36 as sets of three-dimensional coordinates, shown in FIG. 3 as virtual component removal zones 38′. The identifying mark 40b is a visible pattern, such as a barcode, quick-response (QR) code, or other pattern that the sensor 42 detects. The controller 30 identifies the identifying mark 40b based on data from the sensor 42 and retrieves the virtual model 44 from the memory based on the identifying mark 40b. The controller 30 adjusts the removal path such that the removal tool 28 removes the component removal zones 38 identified by the virtual component removal zones 38′ in the virtual model 44, such as by moving the laser of the laser cutter around the perimeter of the component removal zones 38. By using the virtual model 44, covers 36 can optionally include only the identifying mark 40b, rather than an entire printed pattern 40a as in FIG. 2, to indicate to the controller 30 the removal path to remove the component removal zones 38.

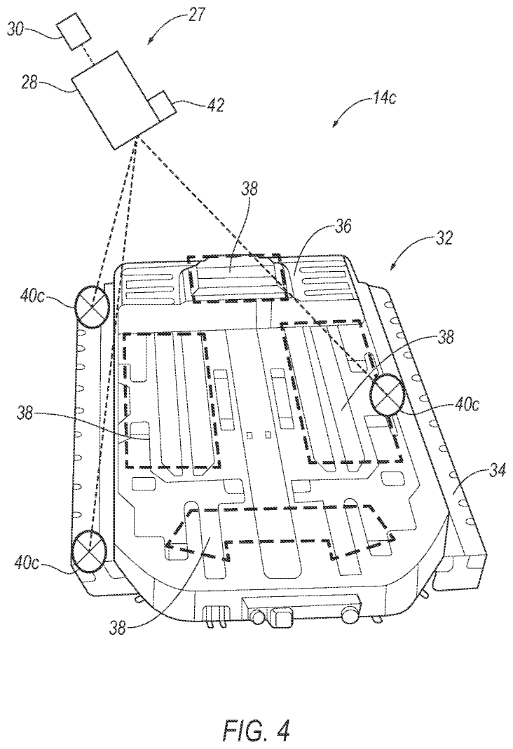

With reference to the battery assembly 14c of FIG. 4, the locator 40c shown is a set of three or more visible markings or three or more physical features (e.g., protrusions or indentions) that are located on the cover 36. Each locator 40c is at a specific three-dimensional position (e.g., predetermined X, Y, and Z coordinates) on the cover 36. Each locator 40c may or may not be located within any of the component removal zones 38. The sensor 42 is configured to detect the locations of the locators 40c.

In the form of FIG. 4, the controller 30 has a predetermined removal path stored in the memory that is based on a specified three-dimensional orientation of the cover 36 in a default three-dimensional coordinate system. When preparing the cover 36 for removal of the component removal zones 38, the cover 36 may become misaligned to this specified three-dimensional orientation, and the predetermined removal path would, thus, remove parts of the cover 36 that are not part of the component removal zones 38.

The controller 30 stores default coordinates of each locator 40c in the default coordinate system, and upon identifying the three-dimensional positions of the locators 40c on the cover 36, the controller 30 determines a new coordinate system based on the positions of the locators 40c.

In an example of such a new coordinate system, if the default coordinates of one of the locators 40c indicates an origin of the default coordinate system (e.g., [0,0,0]), and the controller 30 determines the actual three-dimensional position of the locator 40c is [x, y, z] offset from the origin, the controller 30 can determine a transformation matrix that converts coordinates in the default coordinate system to a new coordinate system at which [x, y, z] is the origin. Such a transformation matrix is conventional in image processing software (such as Pixi3D, OpenGL Viewport, or OpenGL Projection) and is stored in the memory of the controller 30. Then, the controller 30 adjusts the three-dimensional coordinates of the removal path with the transformation matrix to determine and adjusted removal path. In another form, the coordinate systems described herein may be any suitable three-dimensional system, such as spherical or cylindrical coordinate systems.

The controller 30 actuates the removal tool 28 to remove material along the adjusted removal path, which more precisely removes the component removal zones 38 than the default removal path. The controller 30 can use three-dimensional positions from a plurality of locators 40c to determine the transformation matrix, each additional locator 40c refining the transformation into the new coordinate system.

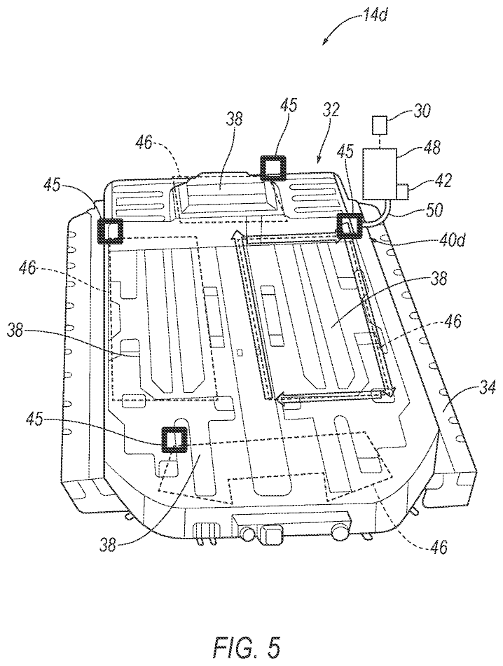

With reference to the battery assembly 14d of FIG. 5, the locator 40d shown includes a tab 45 and a perforated or thinned outline 46 of the component removal zone 38. In this context, a “perforated” outline 46 is a portion of the cover 36 that includes perforations or other openings, typically along a line extending around the component removal zone 38 such that, upon separating the perforations, the component removal zone 38 is separated from the rest of the cover 36. In this context, the “thinned” outline 46 is a portion of the cover 36 that has a lower thickness than surrounding portions of the cover 36 such that, upon application of a force, the thinned outline 46 separates from the surrounding material to separate the component removal zone 38 from the rest of the cover 36.

The tab 40d extends out from the cover 36 and has a conventional shape such as a square ring (as shown in FIG. 5), a circular ring, a solid rectangle, or a triangle. FIG. 5 shows another form of the system 27 in which the removal tool 48 includes a hook 50, which still includes the sensor 42 and is controlled by the controller 30. The tab 40d is attached to the cover 36 on the component removal zone 38 or on the perforated or thinned outline 46, and the removal tool 48 is configured to attach to the tab 40d and to pull the tab 40d away from the cover 36, separating the component removal zone 38 along the perforated or thinned outline 46. In the example shown, the hook 50 is moved into the ring of the tab 40d, and the hook 50 pulls the tab 40d to separate the perforated or thinned outline 46 from the rest of the cover 36 along the arrows shown in FIG. 5.

While each of the locators 40 are shown individually, it is within the scope of the disclosure to use two or more of the locators 40 on a same cover 36 to identify and remove the component removal zones 38, such as storing the virtual model 44 in the controller 30, identifying the virtual model 44 according to the identifying mark 40b, and adjusting the removal path stored in the virtual model 44 based on the transformation matrix determined based on the three-dimensional positions of the protrusions 40c. In addition, while one removal tool 28, 48 is shown in FIGS. 2-5, it is within the scope of the disclosure to include two or more removal tools 28, 48 to remove the component removal zones 38, such as a laser cutter to remove one of the component removal zones 38 and a removal tool 48 with a hook 50 to remove another of the component removal zones 38.

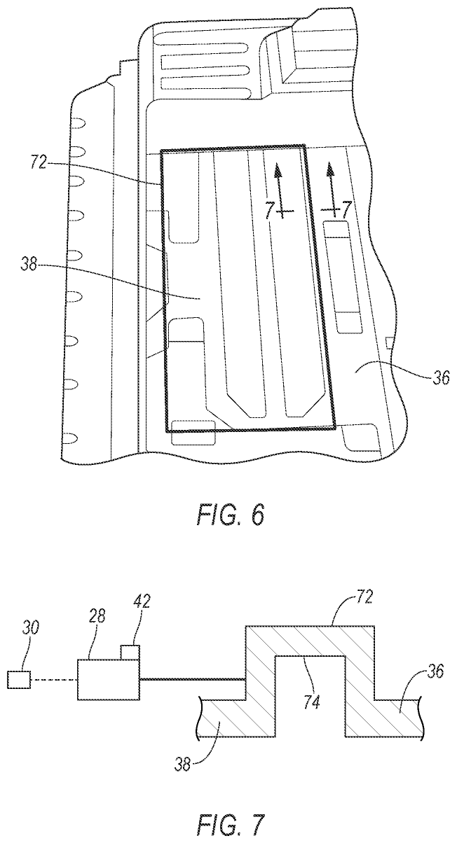

Referring to FIGS. 6 and 7, any of the component removal zones 38 of FIGS. 2-5 may optionally be physically delimited by a protrusion 72 that defines the border between the component removal zone 38 and the rest of the cover 36. The protrusion extends outward from the adjacent regions of the component removal zone 38 and the rest of the cover 36 and defines a channel 74 that is open inward (i.e., toward the components 26 (FIG. 1)). In other words, the protrusion 72 spans a gap between the component removal zone 38 and the rest of the cover 36 surrounding the component removal zone 38. As a result, the removal tool 28 can cut through the protrusion 72 to separate the component removal zone 38 from the rest of the cover 36. The protrusion 72 also permits the removal tool 28 to optionally cut horizontally across the protrusion 72 to reduce the likelihood of the components 26 (FIG. 1) being damaged from the laser beam or cutting device of the removal tool 28 penetrating too far inward.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for removing a component from a battery assembly, the method comprising:
detecting, via a sensor, data identifying a locator on a cover of the battery assembly, the locator indicating a removal zone of the cover;
adjusting, via a controller, a path of a removal tool based on the data identifying the locator;
actuating the removal tool along the adjusted path to separate the removal zone from a remainder of the cover; and
removing the component covered by the removal zone of the cover.

2. The method of claim 1, wherein the locator includes a pattern printed onto the cover, and the method further comprises actuating the removal tool along the pattern to remove the removal zone from the remainder of the cover.

3. The method of claim 1, wherein the locator includes an identifying mark corresponding to a virtual model of the cover, the virtual model indicating the cover and the removable zone of the cover, and the method further comprises adjusting the path of the removal tool based on the virtual model.

4. The method of claim 1, wherein the locator includes a protrusion indicating a three-dimensional position on the cover, and the method further comprises adjusting three-dimensional coordinates of the path of the removal tool based on the three-dimensional position of the protrusion.

5. The method of claim 1, wherein the locator includes a tab and a perforated outline of the removal zone, and the method further comprises attaching the removal tool to the tab, pulling the tab away from the cover, and separating perforations of the perforated outline to separate the removal zone from the remainder of the cover.

6. The method of claim 1, wherein the sensor is configured to collect three-dimensional coordinate data of the cover.

7. The method of claim 6, wherein the sensor is one of a lidar, a sonar, an ultrasonic sensor, an x-ray sensor, an infrared imaging sensor, a neutron imaging sensor, and a vision system.

8. The method of claim 1, wherein the component is one of a cell array, a control module, and an electronic connection.

9. A battery assembly comprising:
a housing including a base and a cover, the base and the cover defining an interior cavity of the housing; and
a battery component disposed within the cavity of the housing,
wherein the cover comprises:
a component removal zone configured to be removed from a remainder of the cover and arranged to cover the battery component; and
a locator identifying the component removal zone for removal.

10. The battery assembly of claim 9, wherein the locator includes a pattern delimiting the component removal zone from the remainder of the cover.

11. The battery assembly of claim 9, wherein the locator includes an identifying mark corresponding to a virtual model of the cover, the virtual model indicating the component removal zone of the cover.

12. The battery assembly of claim 9, wherein the locator includes a protrusion indicating a three-dimensional position on the cover.

13. The battery assembly of claim 9, wherein the locator includes a tab and a perforated or thinned outline of the component removal zone.

14. A system for accessing a component of a battery assembly behind a cover of the battery assembly, the system comprising:
a removal tool configured to separate a component removal zone of the cover from a remainder of the cover;
a sensor configured to detect a locator on the cover of the battery assembly; and
a controller configured to receive data from the sensor and identify a location of the component removal zone based on the received data, wherein the controller is configured to operate the removal along a removal path to separate the component removal zone from the remainder of the cover.

15. The system of claim 14, wherein the removal path includes a plurality of three-dimensional coordinates to remove the component removal zone.

16. The system of claim 15, wherein the controller is programmed to, upon identifying three-dimensional coordinates of the locator, to determine a coordinate transformation between the three-dimensional coordinates of the locator and a default three-dimensional coordinate system of the removal tool.

17. The system of claim 16, wherein the controller is programmed to transform coordinates of a predetermined path into coordinates of an adjusted removal path based on the coordinate transformation.

18. The system of claim 14, wherein the sensor is configured to collect three-dimensional coordinate data of the cover.

19. The system of claim 18, wherein the sensor is one of a lidar, a sonar, an ultrasonic sensor, an x-ray sensor, an infrared imaging sensor, a neutron imaging sensor, and a vision system.

20. The system of claim 14, wherein the removal tool includes one of a laser cutter, a water jet cutter, an oscillating blade, and a rotatable blade.
